(19) United States
(12) Patent Application Publication
(10) Pub. No.: US 2021/0373832 A1
(43) Pub. Date: Dec. 2, 2021

(54) IMAGE FORMING APPARATUS, IMAGE FORMING METHOD, AND NON-TRANSITORY RECORDING MEDIUM STORING COMPUTER PROGRAM

(71) Applicant: TOSHIBA TEC KABUSHIKI KAISHA, Tokyo (JP)

(72) Inventor: Katsunori SUZUKI, Mishima Shizuoka (JP)

(73) Assignee: TOSHIBA TEC KABUSHIKI KAISHA, Tokyo (JP)

(21) Appl. No.: 16/883,506

(22) Filed: May 26, 2020

(51) Int. Cl. G06F 3/12; H04N 1/00

(52) U.S. Cl. CPC G06F 3/1293; H04N 1/00244

(57) ABSTRACT

According to one embodiment, the image forming apparatus includes a memory, a controller, and a communication unit. The memory stores setting information. The controller determines whether or not to transmit image forming data to a distribution server based on the setting information. The communication unit receives the image forming data from the terminal and transmits the image forming data to the distribution server according to the determination.

### FIELD

Embodiments described herein relate generally to an image forming apparatus, an image forming method, and a non-transitory recording medium storing a computer program.

### BACKGROUND

In the related art, printing methods using a print distribution server have been widely used, for example, in companies. In this printing method, data to be printed (hereinafter, referred to as “print data”) transmitted from a user terminal such as a personal computer is temporarily stored in a print distribution server. Thereafter, the user can download the print data from the print distribution server and perform printing on any multifunction peripheral (MFP). However, this printing method uses a printer driver such as a personal computer connected to a network. Therefore, when the user terminal is a portable wireless communication terminal such as a smartphone, the user cannot use the printing method using the print distribution server.

In recent years, with the spread of wireless communication terminals, a technique has been developed for making the functions of the multifunction peripheral available from the wireless communication terminals. With such a technique, a user can perform printing by transmitting print data to a multifunction peripheral capable of wireless connection with a wireless communication terminal. In this case, the wireless communication terminal first displays a list of multifunction peripherals that can be wirelessly connected to its own device and allows the user to select a multifunction peripheral to use. The wireless communication terminal transmits the print data to the selected multifunction peripheral and instructs the multifunction peripheral to print the transmitted print data.

As described above, in the related art, different printing methods have been used depending on the usage environment of the user. As a result, user convenience may be impaired in using the functions of the multifunction peripheral.

The problem to be solved by the present disclosure is to provide an image forming apparatus, an image forming method, and a non-transitory recording medium storing a computer program, which can improve user convenience in using the functions of the multifunction peripheral.

### DESCRIPTION OF THE DRAWINGS

FIG. 1 is a schematic diagram showing a specific example of a multifunction peripheral system;

FIG. 2 is a diagram showing a specific example of a list display screen displayed on a wireless communication terminal;

FIG. 3 is a diagram showing a specific example of a configuration of print instruction information used by a multifunction peripheral;

FIG. 4 is a diagram showing a specific example of print instruction information transmitted from the wireless communication terminal to the multifunction peripheral;

FIG. 5 is a diagram showing a specific example of print instruction information transmitted from the wireless communication terminal to the multifunction peripheral;

FIG. 6 is a diagram showing a specific example of print instruction information transmitted from the wireless communication terminal to the multifunction peripheral;

FIG. 7 is a diagram showing a specific example of a configuration of first profile information;

FIG. 8 is a diagram showing a specific example of print instruction information transmitted from the wireless communication terminal to the multifunction device;

FIG. 9 is a diagram showing a specific example of the configuration of second profile information;

FIG. 10 is a diagram showing a specific example of a configuration of third profile information;

FIG. 11 is a diagram showing a specific example of print instruction information transmitted from the wireless communication terminal to the multifunction peripheral;

FIG. 12 is a diagram showing a specific example of a selection screen displayed on the wireless communication terminal;

FIG. 13 is a diagram showing a configuration example of the wireless communication terminal;

FIG. 14 is a diagram showing a configuration example of the multifunction peripheral;

FIG. 15 is a diagram showing a configuration example of a print distribution server; and

FIG. 16 is a sequence diagram illustrating a flow of a process performed by the multifunction peripheral system.

### DETAILED DESCRIPTION

In general, according to one embodiment, an image forming apparatus includes a memory, a controller, and a communication unit. The memory stores setting information. The controller determines whether or not to transmit image forming data to a distribution server based on the setting information. The communication unit receives image forming data from a terminal and transmits the image forming data to the distribution server according to the determination.

Hereinafter, an image forming apparatus, an image forming method, and a non-transitory recording medium storing a computer program according to an embodiment will be described with reference to the drawings.

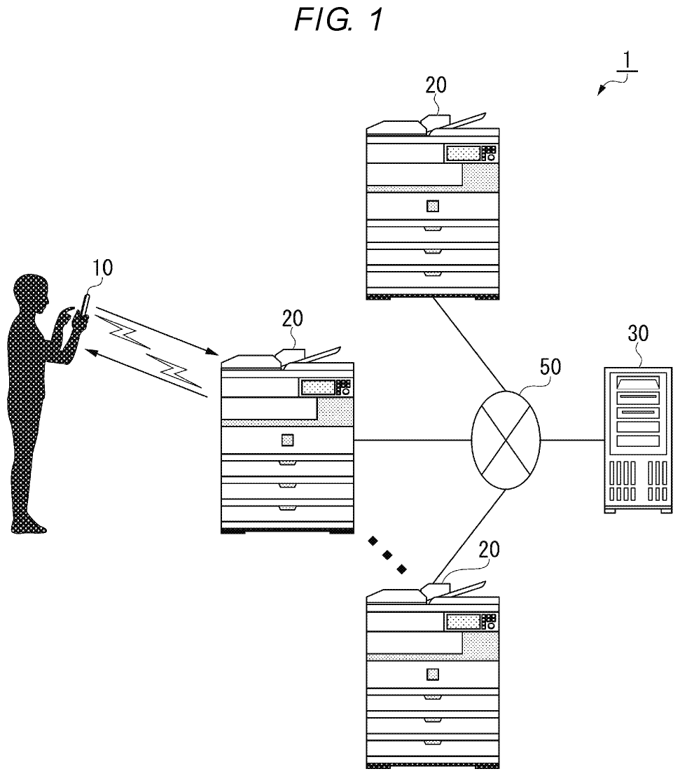

FIG. 1 is a schematic diagram showing a specific example of a multi function peripheral system 1 according to the present embodiment. The multifunction peripheral system 1 is a system that makes various functions of a multifunction peripheral 20 available from a wireless communication terminal 10. For example, the wireless communication terminal 10 is an information communication terminal having a wireless communication function, such as a smartphone or a tablet. The wireless communication terminal 10 and the multifunction peripheral 20 are configured to be able to communicate with each other. The number of multifunction peripherals 20 constituting the multifunction peripheral system 1 is any number, but in the present embodiment, it is assumed that there are a plurality of multifunction peripherals 20 as shown in FIG. 1.

For example, an application (hereinafter, referred to as “multifunction peripheral application”) that enables the functions of the multifunction peripheral 20 to be used via wireless communication is installed in the wireless communication terminal 10. By operating the multifunction peripheral application, the user can remotely use various functions of the multifunction peripheral 20 (hereinafter, referred to as “multifunction peripheral functions”). For example, the multifunction peripheral function includes a printer function, a scanner function, a copy function, a facsimile function, and the like.

As an example of such a multi function peripheral function, the printer function is shown in FIG. 1. FIG. 1 shows an example of the multifunction peripheral system 1 in which the wireless communication terminal 10 can use the printer function of the multifunction peripheral 20. First, the user operates the multifunction peripheral application of the wireless communication terminal 10 to search for a multifunction peripheral 20 that can be used from the wireless communication terminal 10. On the wireless communication terminal 10, a list of the multifunction peripherals 20 detected by the search is displayed. Hereinafter, a screen on which the wireless communication terminal 10 displays a list of the multifunction peripherals 20 is referred to as a “list display screen”.

Next, the user selects a multifunction peripheral 20 displayed on the list display screen. Thereby, the print instruction information (setting information) and the print data (image forming data) are transmitted from the wireless communication terminal 10 to the selected multifunction peripheral 20. The print instruction information is information in which the information for determining what kind of process is performed on the print data by the multifunction peripheral 20 that has acquired the print data (for example, information regarding the wireless communication terminal 10, information regarding the print data, and the like) is defined. The details of the print instruction information will be described below.

Next, the multifunction peripheral 20 acquires the print instruction information and the print data transmitted from the wireless communication terminal 10. The multifunction peripheral 20 determines a process to be performed on the acquired print data based on the acquired print instruction information. For example, the multifunction peripheral 20 determines to transmit the print data to a print distribution server 30 based on the acquired print instruction information. Alternatively, for example, the multifunction peripheral 20 determines to execute print processing (print) based on the print data, based on the acquired print instruction information. As described above, the multifunction peripheral 20 executes a process based on the result of the above determination.

As shown in FIG. 1, the multifunction peripheral 20 and the print distribution server 30 are communicatively connected by a network 50. The print distribution server 30 may be, for example, a server on an intranet or a server on the Internet. Further, one of the multifunction peripherals 20 may be configured to have a function of the print distribution server 30. Further, there may be a plurality of print distribution servers 30.

For example, if the multifunction peripheral 20 determines to transmit the print data to the print distribution server 30, the multifunction peripheral 20 transmits the print data to the print distribution server 30 via the network 50. Although not shown in FIG. 1, a personal computer (PC) used by a user may be connected to the network 50, for example. Thus, for example, when the PC uses the printer function of the multifunction peripheral 20, the print data is transmitted from the printer driver of the PC to the print distribution server 30 via the network 50. Thereby, the user can download and print the print data stored in the print distribution server 30 in any multifunction peripheral 20.

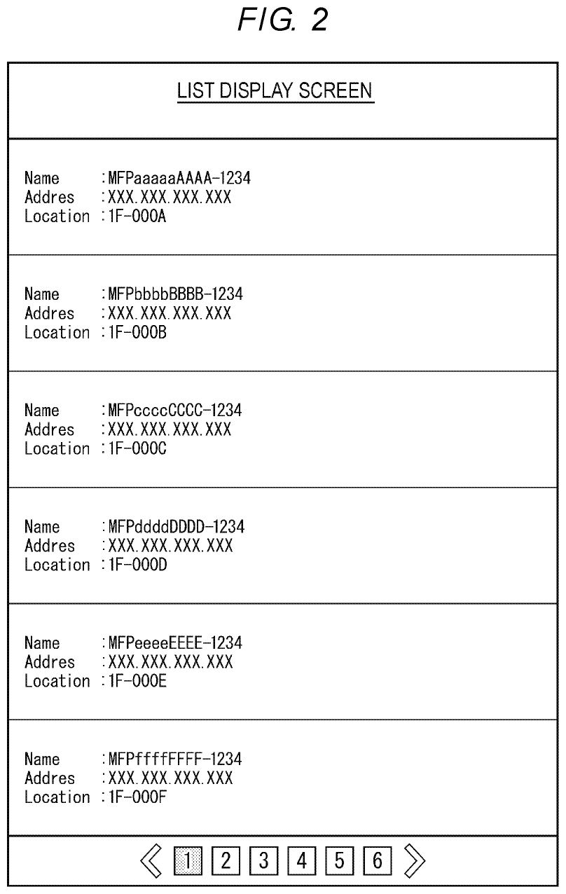

In the use of such a function of the multifunction peripheral, the wireless communication terminal 10 displays, for example, a list display screen as shown in FIG. 2.

FIG. 2 is a diagram showing a specific example of a list display screen displayed on the wireless communication terminal 10 in the multifunction peripheral system 1. For example, FIG. 2 shows a list display screen on which six multifunction peripherals 20 detected by the search are displayed. Hereinafter, information on each multifunction peripheral 20 displayed on such a list display screen is referred to as “device information”. FIG. 2 shows an example of a list display screen that displays, as device information, a name (Name), address information (Address), and an installation location (Location) for each multifunction peripheral 20. The user can instruct the execution of a desired multifunction peripheral function by selecting any multifunction peripheral 20 from the multifunction peripherals 20 displayed in the list.

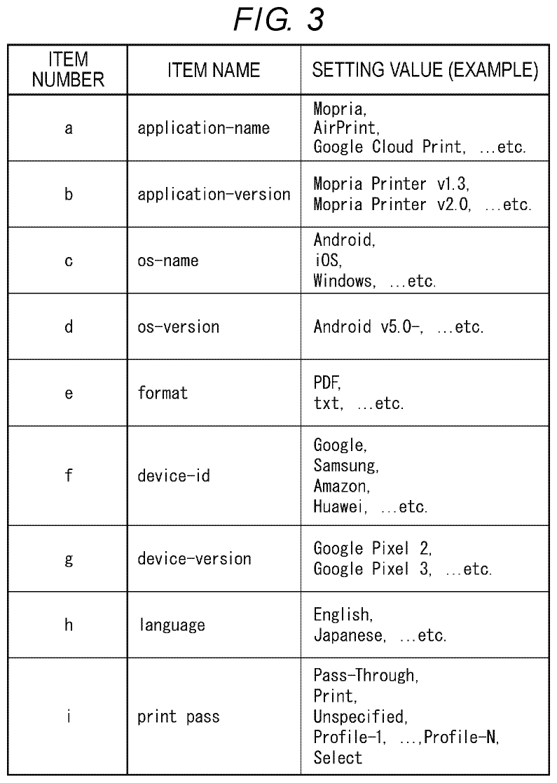

Further, in the use of such a multifunction peripheral function, the wireless communication terminal 10 transmits, for example, the print instruction information having the data configuration as shown in FIG. 3 to the multifunction peripheral 20.

FIG. 3 is a diagram showing an example of the configuration of print instruction information used by the multifunction peripheral 20 in the multifunction peripheral system 1. As shown in FIG. 3, the print instruction information includes, for example, nine items from item number “a” to item number “i.”

The item number a is associated with an item having an item name of “application-name”. In the item “application-name”, a setting value indicating the name of the multifunction peripheral application installed in the wireless communication terminal 10 is set. For example, in the item “application-name”, a setting value such as “Mopria (registered trademark)”, “AirPrint (registered trademark)”, or “Google Cloud Print (registered trademark)” is set.

The item number b is associated with an item having an item name of “application-version”. In the item “application-version”, a setting value indicating the version number of the multifunction peripheral application installed in the wireless communication terminal 10 is set. For example, in the item “application-version”, a setting value such as “Mopria (registered trademark) Printer v1.3” or “Mopria (registered trademark) Printer v2.0” is set.

The item number c is associated with an item having an item name of “os-name”. In the item “os-name”, a setting value indicating the name of the operating system (OS) installed in the wireless communication terminal 10 is set. For example, in the item “os-name”, a setting value such as “Android (registered trademark)”, “iOS (registered trademark)”, or “Windows (registered trademark)” is set.

The item number d is associated with an item having an item name of “os-version”. In the item “os-version”, a setting value indicating the version number of the operating system (OS) installed in the wireless communication terminal 10 is set. For example, in the item “os-version”, a setting value such as “Android (registered trademark) v5.0-” is set. “Android (registered trademark) v5.0-” is a setting value indicating a version number of Android (registered trademark) 5.0 or later.

The item number e is associated with an item having an item name of “format”. In the item “format”, a setting value indicating the file format of the print data transmitted from the wireless communication terminal 10 is set. For example, in the item “format”, a setting value such as “PDF” (Portable Document Format) or “txt” is set. “txt” is a setting value indicating a text file.

The item number f is associated with an item having an item name of “device-id”. In the item “device-id”, a setting value for identifying the type of the wireless communication terminal 10 is set. For example, in the item “device-id”, a setting value such as “Google (registered trademark)”, “Samsung (registered trademark)”, “Amazon (registered trademark)”, or “Huawei (registered trademark)” is set.

The item number g is associated with an item having an item name of “device-version”. In the item “device-version”, a setting value indicating the version number of the wireless communication terminal 10 is set. For example, in the item “device-version”, a setting value such as “Google Pixel (registered trademark) 2” or “Google Pixel (registered trademark) 3” is set.

The item number h is associated with an item having an item name of “language”. In the item “language”, a setting value indicating the language of the print data transmitted from the wireless communication terminal 10 is set. For example, in the item of “language”, a setting value such as “English” or “Japanese” is set. In the item of “language”, for example, a setting value indicating a language supported by the multifunction peripheral application may be set.

The item number i is associated with an item having an item name “print pass”. In the item “print pass”, a setting value indicating a method of executing the printer function is set. For example, in the item “print pass”, a setting value such as “Pass-Through”, “Print”, “Select”, “Profile-1” to “Profile-N”, or “Unspecified” is set.

Hereinafter, each setting value set in the item “print pass” will be described.

“Pass-Through” is a setting value indicating that the multifunction peripheral 20 transmits the print data acquired from the wireless communication terminal 10 to the print distribution server 30 (hereinafter, referred to as “pass-through”).

“Print” is a setting value indicating that the multifunction peripheral 20 that has acquired the print data executes print processing based on the print data. In other words, “Print” is a setting value indicating that the multifunction peripheral 20 that has acquired the print data immediately executes print processing instead of passing through.

“Unspecified” is a setting value indicating that the printer function is executed according to a rule preset on the multifunction peripheral 20 side. For example, the rule preset in the multifunction peripheral 20 is a rule defined in default (basic setting) profile information. The details of the profile information will be described later.

“Profile-1” to “Profile-N” are setting values indicating that the printer function is executed according to any of N pieces (N is any positive number) of profile information preset on the multifunction peripheral 20 side. For example, if the setting value of the item “print pass” is “Profile-3”, the printer function is executed according to third profile information. The third profile information is one of the N pieces of profile information.

“Select” is a setting value indicating that the printer function is executed according to the selection by the user. In this case, a selection screen for allowing the user to select a desired execution method of the printer function is displayed in a pop-up on the wireless communication terminal 10. The details of the selection screen will be described later.

If there is no “print pass” information, or if the item does not exist, the printer function operates under the condition of default (basic setting) profile information.

Hereinafter, processing examples for each setting value of the item number i “print pass” will be described.

First, a case where the setting value of the item of item number i “print pass” is “Pass-Through” will be described.

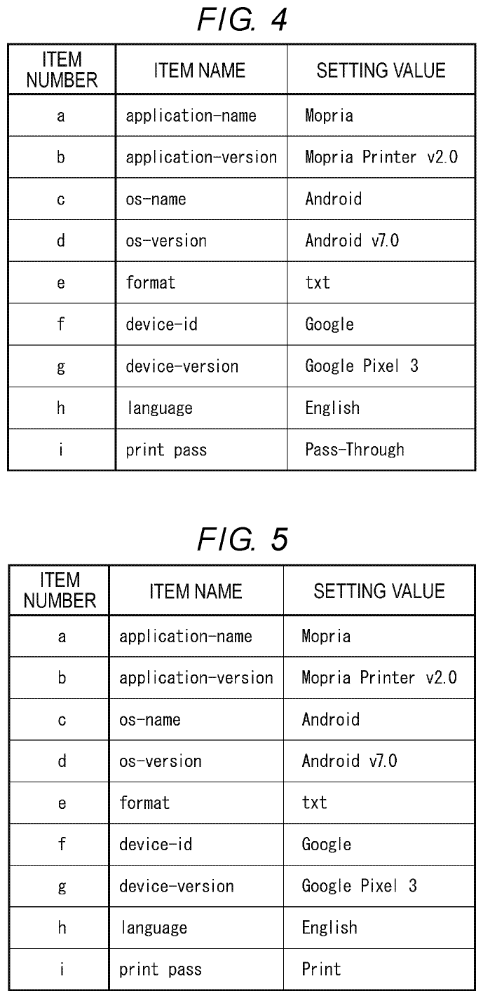

FIG. 4 is a diagram showing an example of print instruction information transmitted from the wireless communication terminal 10 to the multifunction peripheral 20. As shown in FIG. 4, the setting value of the item of the item number a “application-name” is “Mopria (registered trademark)”. That is, the name of the multifunction peripheral application installed in the wireless communication terminal 10 is Mopria (registered trademark). The setting value of the item of item number b “application-version” is “Mopria (registered trademark) Printer v2.0”. That is, the version number of the multifunction peripheral application installed in the wireless communication terminal 10 is Mopria (registered trademark) Printer version 2.0.

The setting value of the item of the item number c “os-name” is “Android (registered trademark)”. That is, the name of the OS installed in the wireless communication terminal 10 is Android (registered trademark). The setting value of the item of the item number d “os-version” is “Android (registered trademark) v7.0”. That is, the version number of the OS installed in the wireless communication terminal 10 is Android (registered trademark) version 7.0. The setting value of the item of the item number e “format” is “txt”. That is, the file format of the print data transmitted from the wireless communication terminal 10 is a text format.

The setting value of the item of item number f “device-id” is “Google (registered trademark)”. That is, the type of the wireless communication terminal 10 is (a model of) Google (registered trademark). The setting value of the item of the item number g “device-version” is “Google Pixel (registered trademark) 3”. That is, the version number of the wireless communication terminal 10 is Version 3 of Google Pixel (registered trademark). The setting value of the item of the item number h “language” is “English”. That is, the language of the print data transmitted from the wireless communication terminal 10 is English.

Also, as shown in FIG. 4, the setting value of the item of the item number i “print pass” of the print instruction information is “Pass-Through”. When the multifunction peripheral 20 acquires such print instruction information from the wireless communication terminal 10, the multifunction peripheral 20 passes through the print data acquired from the wireless communication terminal 10. That is, when the setting value of the item of the item number i “print pass” is “Pass-Through”, the print data is passed through regardless of the setting values of the items of the item numbers a to h. Then, the print data is temporarily stored in the print distribution server 30. Thereafter, the user can download the print data from the print distribution server 30 and print the print data in any multifunction peripheral 20.

Next, a case where the setting value of the item of item number i “print pass” is “Print” will be described.

FIG. 5 is a diagram showing an example of print instruction information transmitted from the wireless communication terminal 10 to the multifunction peripheral 20. Since the setting values of the items of the item numbers a to h in the print instruction information shown in FIG. 5 are the same as the setting values of the items of the item numbers a to h in the print instruction information shown in FIG. 4, the descriptions thereof will be omitted.

As shown in FIG. 5, the setting value of the item of the item number i “print pass” of the print instruction information is “Print”. When the multifunction peripheral 20 acquires such print instruction information from the wireless communication terminal 10, the multifunction peripheral 20 executes print processing based on the print data acquired from the wireless communication terminal 10. That is, when the setting value of the item of the item number i “print pass” is “Print”, the print processing is immediately executed by the multifunction peripheral 20 that has acquired the print data regardless of the setting values of the items of the item numbers a to h.

Next, a case where the setting value of the item of item number i “print pass” is “Unspecified” will be described.

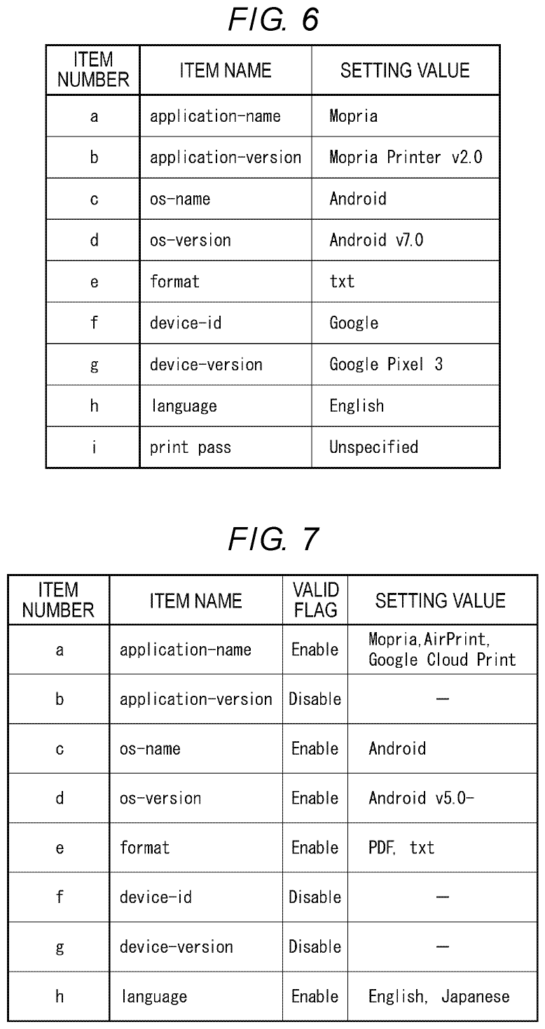

FIG. 6 is a diagram showing an example of print instruction information transmitted from the wireless communication terminal 10 to the multifunction peripheral 20. Since the setting values of the items of the item numbers a to h of the print instruction information shown in FIG. 6 are the same as the setting values of the items of the item numbers a to h in the print instruction information shown in FIG. 4, the descriptions thereof will be omitted.

As shown in FIG. 6, the setting value of the item of the item number i “print pass” of the print instruction information is “Unspecified”. When the multifunction peripheral 20 acquires such print instruction information from the wireless communication terminal 10, the multifunction peripheral 20 determines whether to execute pass-through or to immediately execute print processing based on the print instruction information and the default (basic setting) profile information preset in the multifunction peripheral 20 side. Here, it is assumed that the default (basic setting) profile information is first profile information (Profile-1), which is one of the N pieces of profile information installed in the multifunction peripheral 20 in advance.

FIG. 7 is a diagram showing an example of the configuration of the first profile information. The data configurations of second profile information (Profile-2) to N-th profile information (Profile-N) are the same as that of the first profile information. As shown in FIG. 7, the profile information includes, for example, eight items from item number a to item number h. Each of the eight items is associated with a valid flag value. The valid flag value may be “Enable” or “Disable”. In addition, at least one setting value is further set in the item in which the valid flag value is “Enable”.

The multifunction peripheral 20 collates the setting value of the item in the print instruction information acquired from the wireless communication terminal 10 and the setting value of the item in the preset profile information for the item in which the valid flag value is “Enable”. If at least one of the setting values set for the item of the profile information matches the setting value of the same item included in the print instruction information, the multifunction peripheral 20 determines to execute pass-through. On the other hand, the multifunction peripheral 20 does not perform the above-described collation process on the item in which the valid flag value is “Disable”.

The multifunction peripheral 20 performs the above-described collation process on all the items in which the valid flag value is “Enable”, and finally determines whether or not to perform pass-through. For example, in all the items in which the valid flag value is “Enable”, if at least one of the setting values set for the item of the profile information matches the setting value of the same item included in the print instruction information, the multifunction peripheral 20 determines to perform pass-through. That is, the multifunction peripheral 20 determines to perform pass-through when the AND condition is satisfied.

For example, in the first profile information shown in FIG. 7, the items in which the valid flag value is “Enable” are the item number a “application-name”, the item number c “os-name”, the item number d “os-version”, the item number e “format” and the item number h “language”. On the other hand, in the print instruction information shown in FIG. 6, the setting value of the item of the item number a “application-name” is “Mopria (registered trademark)”. This setting value matches one of the setting values set in the item number a “application-name” in the first profile information shown in FIG. 7.

Also, in the print instruction information shown in FIG. 6, the setting value of the item of the item number c “os-name” is “Android (registered trademark)”. This setting value matches the setting value set in the item number c “os-name” in the first profile information shown in FIG. 7. Also, in the print instruction information shown in FIG. 6, the setting value of the item of the item number d “os-version” is “Android (registered trademark) v7.0”. This setting value satisfies “Android (registered trademark) v5.0-” (that is, Android (registered trademark) version 5.0 or higher) which is the setting value set in the item number d “os-version” in the first profile information shown in FIG. 7.

Also, in the print instruction information shown in FIG. 6, the setting value of the item of the item number e “format” is “txt”. This setting value matches one of the setting values set in the item number e “format” in the first profile information shown in FIG. 7. Also, in the print instruction information shown in FIG. 6, the setting value of the item of the item number h “language” is “English”. This setting value matches one of the setting values set in the item number h “language” in the first profile information shown in FIG. 7.

As described above, in all the items in which the valid flag value is “Enable”, at least one of the setting values set for the item of the first profile information matches the setting value of the same item included in the print instruction information. From this, the multifunction peripheral 20 determines to perform pass-through.

For example, in at least one item in which the valid flag value is “Enable”, if at least one of the setting values set for the item of profile information matches the setting value of the same item included in the print instruction information, the multifunction peripheral 20 may determine to perform pass-through. That is, the multifunction peripheral 20 may determine to perform pass-through when the OR condition is satisfied.

As described above, when the setting value of the item of the item number i “print pass” is “Unspecified”, the multifunction peripheral 20 collates the print instruction information acquired from the wireless communication terminal 10 and the default (basic setting) profile information to determine whether or not to perform pass-through. When it is determined that the pass-through is not performed, the multifunction peripheral 20 immediately executes the print processing. That is, the multifunction peripheral 20 executes the same processing as when the setting value of the item of the item number i “print pass” is “Print”.

Next, a case where the setting value of the item of the item number i “print pass” is “Profile-1” to “Profile-N” will be described. Here, as an example, a case where the setting value of the item of the item number i “print pass” is “Profile-3” will be described.

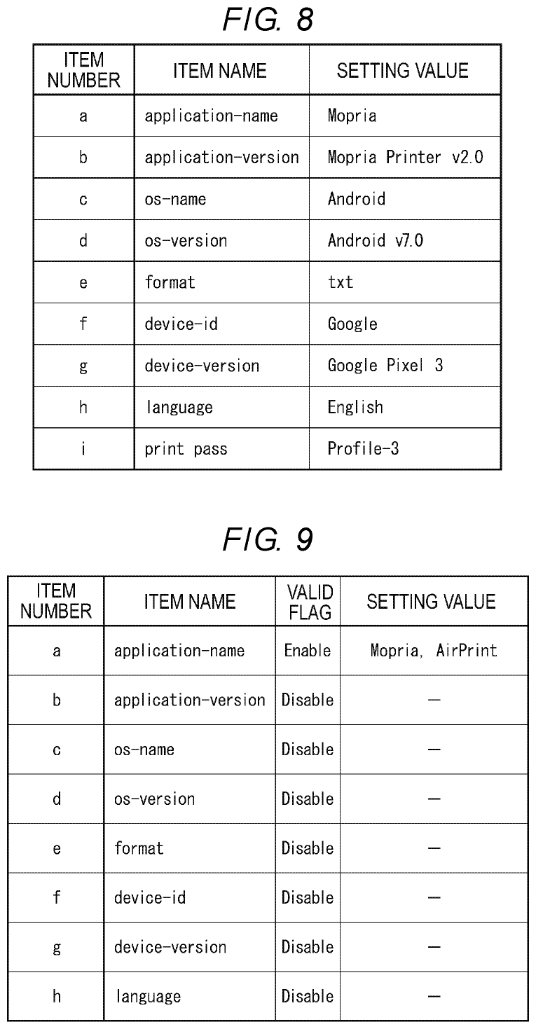

FIG. 8 is a diagram showing an example of print instruction information transmitted from the wireless communication terminal 10 to the multifunction peripheral 20. Since the setting values of the items of the item numbers a to h in the print instruction information shown in FIG. 8 are the same as the setting values of the items of the item numbers a to h in the print instruction information shown in FIG. 4, the descriptions thereof will be omitted.

As shown in FIG. 8, the setting value of the item of the item number i “print pass” in the print instruction information is “Profile-3.” When the multifunction peripheral 20 acquires such print instruction information from the wireless communication terminal 10, the multifunction peripheral 20 determines whether to perform pass-through or to immediately execute print processing based on the print instruction information and the third profile information, which is one of a plurality of pieces of profile information preset on the multifunction peripheral 20 side. For example, N pieces of profile information from first profile information to N-th profile information are set in the multifunction peripheral in advance. The configuration of the first profile information is, for example, as in the above-described FIG. 7. Further, examples of the configuration of the second profile information and the third profile information are shown in FIGS. 9 and 10, respectively.

As shown in FIG. 9, the second profile information is profile information in which only the valid flag value of the item of the item number a “application-name” is “Enable”. Therefore, when the second profile information is used, the multifunction peripheral 20 determines whether or not to pass through according to only the setting value set in the item of the item number a “application-name” in the print instruction information.

As shown in FIG. 10, the third profile information is profile information in which the valid flag value of the item of the item number a “application-name” and the valid flag value of the item of the item number b “application-version” are “Enable”. As described above, here, the setting value of the item of the item number i “print pass” in the print instruction information transmitted from the wireless communication terminal 10 is “Profile-3”.

On the other hand, in the print instruction information shown in FIG. 8, the setting value of the item of the item number a “application-name” is “Mopria (registered trademark)”. This setting value matches the setting value set in the item number a “application-name” in the third profile information shown in FIG. 10. Also, in the print instruction information shown in FIG. 8, the setting value of the item of the item number b “application-version” is “Mopria (registered trademark) Printer v2.0”. This setting value matches one of the setting values set in the item number b “application-version” in the third profile information shown in FIG. 10. As described above, in all (two) items in which the valid flag value is “Enable”, at least one of the setting values set for the item of the third profile information matches the setting value of the same item included in the print instruction information. From this, the multifunction peripheral 20 determines to perform pass-through.

For example, in at least one item in which the valid flag value is “Enable”, if at least one of the setting values set for the item of profile information matches the setting value of the same item included in the print instruction information, the multifunction peripheral 20 may determine to perform pass-through. That is, the multifunction peripheral 20 may determine to perform pass-through when the OR condition is satisfied.

As described above, when the setting value of the item of the item number i “print pass” is “Profile-1” to “Profile-N”, the multifunction peripheral 20 collates the print instruction information acquired from the wireless communication terminal 10 and the profile information indicated by the setting value of the item of the item number i “print pass” to determine whether or not to perform pass-through. When it is determined that the pass-through is not performed, the multifunction peripheral 20 immediately executes the print processing. That is, the multifunction peripheral 20 executes the same processing as when the setting value of the item of the item number i “print pass” is “Print.”

The difference between the case where the setting value of the item of the item number i “print pass” is “Unspecified” and the case where the setting value is “Profile-1” to “Profile-N” is as follows. When the setting value of the item of the item number i “print pass” is “Unspecified,” profile information (for example, first profile information) defined as a default (basic setting) on the multifunction peripheral 20 side is used. The type of profile information to be set as a default (basic setting) is managed on the multifunction peripheral 20 side. That is, the multifunction peripheral 20 can determine profile information to be used. On the other hand, when the setting value of the item of the item number i “print pass” is “Profile-1” to “Profile-N”, the multifunction peripheral 20 performs the process using the profile information specified by the wireless communication terminal 10. That is, the wireless communication terminal 10 can determine profile information to be used.

Next, a case where the setting value of the item of the item number i “print pass” is “Select” will be described.

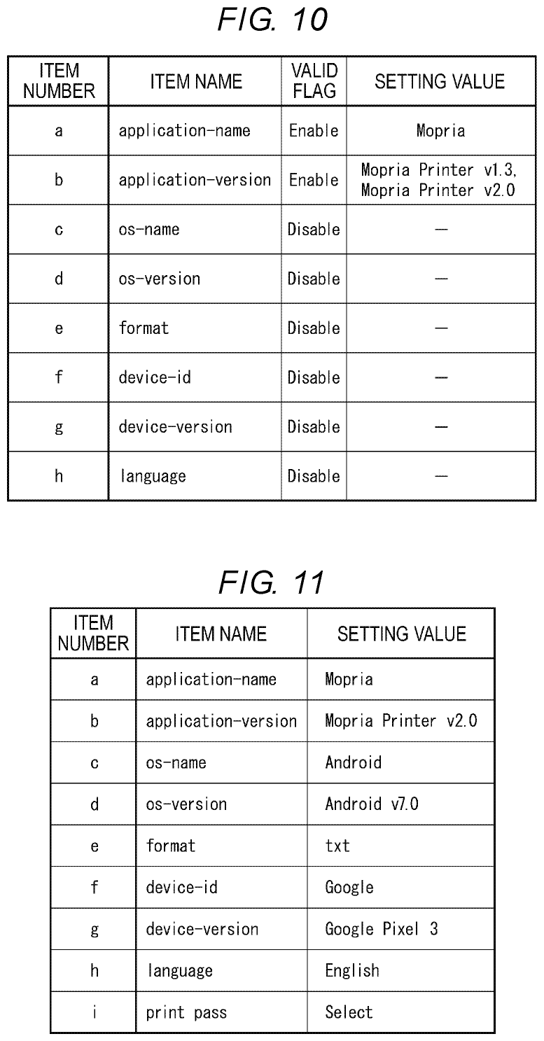

FIG. 11 is a diagram showing a specific example of print instruction information transmitted from the wireless communication terminal 10 to the multifunction peripheral 20. Since the setting values of the items of the item numbers a to h in the print instruction information shown in FIG. 11 are the same as the setting values of the items of the item numbers a to h in the print instruction information shown in FIG. 4, the descriptions thereof will be omitted.

As shown in FIG. 11, the setting value of the item of the item number i “print pass” of the print instruction information is “Select”. When such print instruction information is set in the wireless communication terminal 10, a selection screen for allowing the user to select a desired execution method of the printer function is displayed in a pop-up on the wireless communication terminal 10. The selection screen is displayed, for example, before the print data is transmitted from the wireless communication terminal 10 to the multifunction peripheral 20.

Hereinafter, an example of the selection screen is illustrated.

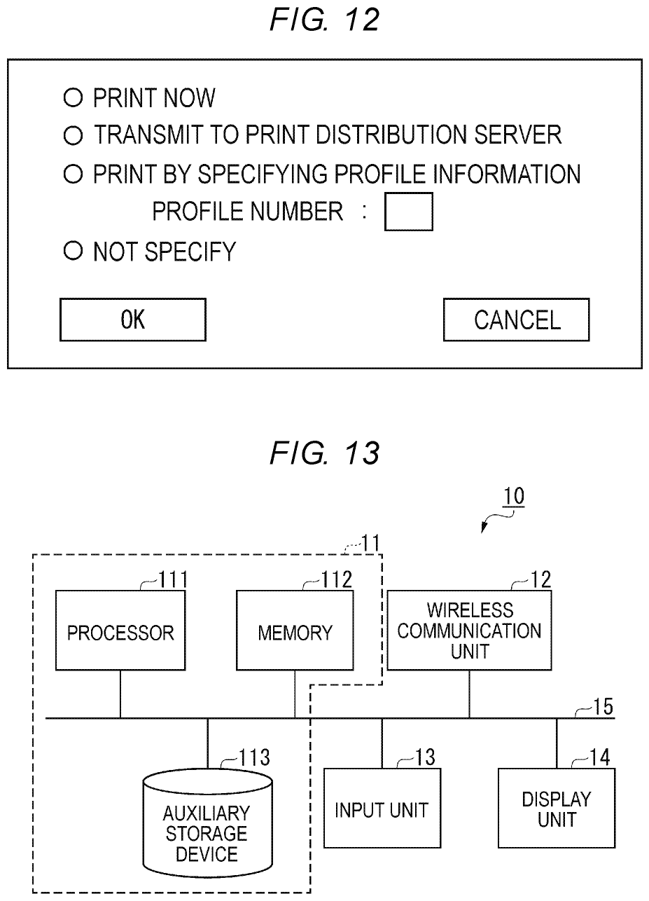

FIG. 12 is a diagram showing a specific example of the selection screen displayed on the wireless communication terminal 10. As shown in FIG. 12, four radio buttons are displayed on the selection screen, and the user is prompted to select a method of executing the multifunction peripheral function by the multifunction peripheral 20.

On the right side of the first radio button, a character string of “Print Now” is displayed. When the first radio button is selected by the user, print processing is immediately performed by the multifunction peripheral 20 that has acquired the print data. That is, the same processing as when the setting value of the item of the item number i “print pass” is “Print” is performed by the multifunction peripheral 20. The first radio button is selected, for example, when the user knows, for example, the installation location of the multifunction peripheral 20 specified on the list display screen shown in FIG. 2 and desires to print immediately.

On the right side of the second radio button, a character string of “Transmit to Print Distribution Server” is displayed. When the second radio button is selected by the user, the multifunction peripheral 20 transmits the acquired print data to the print distribution server. That is, the same processing as when the setting value of the item of the item number i “print pass” is “Pass-Through” is performed by the multifunction peripheral 20. The second radio button is selected, for example, when the user specifies, for example, any multifunction peripheral 20 on the list display screen shown in FIG. 2 and does not know the installation location of the multifunction peripheral 20.

On the right side of the third radio button, a character string of “Print by Specifying Profile Information” is displayed. In addition, below the character string, a character string of “Profile Number:” and a text box are displayed. When the third radio button is selected by the user, the multifunction peripheral 20 executes the printer function according to the profile information corresponding to the number input in the text box. That is, the same processing as when the setting value of the item of the item number i “print pass” is “Profile-1” to “Profile-N” is performed by the multifunction peripheral 20. For example, when “3” is input in the text box, the printer function is executed according to the third profile information (Profile-3).

On the right side of the fourth radio button, a character string of “Not Specify” is displayed. When the fourth radio button is selected by the user, the multifunction peripheral 20 executes the printer function according to the rule preset on the multifunction peripheral 20 side. That is, the same processing as when the setting value of the item of the item number i “print pass” is “Unspecified” is performed by the multifunction peripheral 20.

For example, information indicating a result selected by the user on the selection screen is transmitted from the wireless communication terminal 10 to the multifunction peripheral 20 separately from the print data and the print instruction information. Alternatively, for example, in response to the result selected by the user on the selection screen, the wireless communication terminal 10 may appropriately rewrite the setting value of the item of the item number i “print pass” and transmit the print instruction information to the multifunction peripheral 20.

As described above, when the setting value of the item of the item number i “print pass” is “Select”, the multifunction peripheral 20 determines whether or not to perform pass-through based on the processing method selected by the user. When it is determined that the pass-through is not performed, the multifunction peripheral 20 immediately executes the print processing.

In the present embodiment, the print instruction information is configured by nine items from item number a to item number i, but the present disclosure is not limited thereto. For example, the print instruction information may include information indicating the name of the multifunction peripheral 20, the IP address assigned to the wireless communication terminal 10, the file size of the print data, and the like. Thus, the multifunction peripheral 20 can determine whether or not to pass through based on the name of the multifunction peripheral 20, the IP address, the file size, and the like included in the print instruction information.

Hereinafter, the configuration of the wireless communication terminal 10 will be described.

FIG. 13 is a diagram showing a configuration example of the wireless communication terminal 10 in the present embodiment. For example, the wireless communication terminal 10 includes a processor 111, a memory 112, an auxiliary storage device 113 (also a memory), a wireless communication unit 12, an input unit 13, a display unit 14, and a bus 15 connecting those units. The wireless communication terminal 10 functions as one information processing device having a wireless communication function by causing the processor 111 to read a program stored in the auxiliary storage device 113 into the memory 112 and execute the program. For example, the program referred to here is a program such as a basic input output system (BIOS), an OS, and various pieces of firmware.

The processor 111, the memory 112, and the auxiliary storage device 113 are not limited to specific ones as long as the wireless communication terminal 10 can function as one information processing device having a wireless communication function. For example, the processor 111 is a Central Processing Unit (CPU). The processor 111 may include a Graphics Processing Unit (GPU). Further, for example, the memory 112 is a Random Access Memory (RAM). The memory 112 may include a Read Only Memory (ROM). The auxiliary storage device 113 is configured using a storage device such as a magnetic hard disk device or a semiconductor storage device.

All or a part of each function of the wireless communication terminal 10 may be realized using hardware such as an Application Specific Integrated Circuit (ASIC), a Programmable Logic Device (PLD), and a Field-Programmable Gate Array FPGA). The program may be recorded on a computer-readable recording medium. The computer-readable recording medium is, for example, a portable medium such as a flexible disk, a magneto-optical disk, a ROM, a Compact Disc-Read Only Memory (CD-ROM), or a storage device such as a hard disk built in a computer system. The program may be transmitted via a telecommunication line.

The processor 111, the memory 112, and the auxiliary storage device 113 function as a control unit 11. The control unit 11 plays a role as a controller that causes the wireless communication terminal 10 to function as one information processing device having a wireless communication function. The control unit 11 has a function of instructing the multifunction peripheral 20 to execute the multifunction peripheral function by executing the multifunction peripheral application.

Specifically, the control unit 11 has a function of searching for available multifunction peripherals 20 in accordance with a user's input operation and acquiring device information from each found multifunction peripheral 20. Further, the control unit 11 has a function of generating a list display screen showing available multifunction peripherals 20 based on the device information acquired from each multifunction peripheral 20. In addition, the control unit 11 has a function of displaying the generated list display screen on a display unit 34 and instructing the multifunction peripheral 20 selected from the list display screen to execute the specified multifunction peripheral function.

The wireless communication unit 12 is configured using a wireless communication interface. The wireless communication unit 12 connects the wireless communication terminal 10 and the multifunction peripheral 20 to be able to communicate with each other. For example, the wireless communication interface is a wireless LAN communication interface such as Wi-Fi (registered trademark). Alternatively, for example, the wireless communication interface may be a communication interface connected to a mobile phone network such as 3rd Generation (3G) or 4th Generation (4G).

The input unit 13 is configured using input devices such as a touch panel, a mouse, and a keyboard. The input unit 13 receives inputs of various operations on the wireless communication terminal 10 and outputs the input information to the processor 111. The processor 111 instructs the multifunction peripheral 20 to execute various multifunction peripheral functions by causing the multifunction peripheral application to execute a process corresponding to the input information.

The display unit 14 is configured using a display device such as a Cathode Ray Tube (CRT) display, a liquid crystal display, and an organic Electro Luminescence (EL) display. The display unit 14 displays various information related to the operation of the wireless communication terminal 10. For example, the display unit 14 displays an operation screen of the multifunction peripheral application. Information to be displayed by the display unit 14 is output from the processor 111.

Hereinafter, the configuration of the multifunction peripheral 20 will be described.

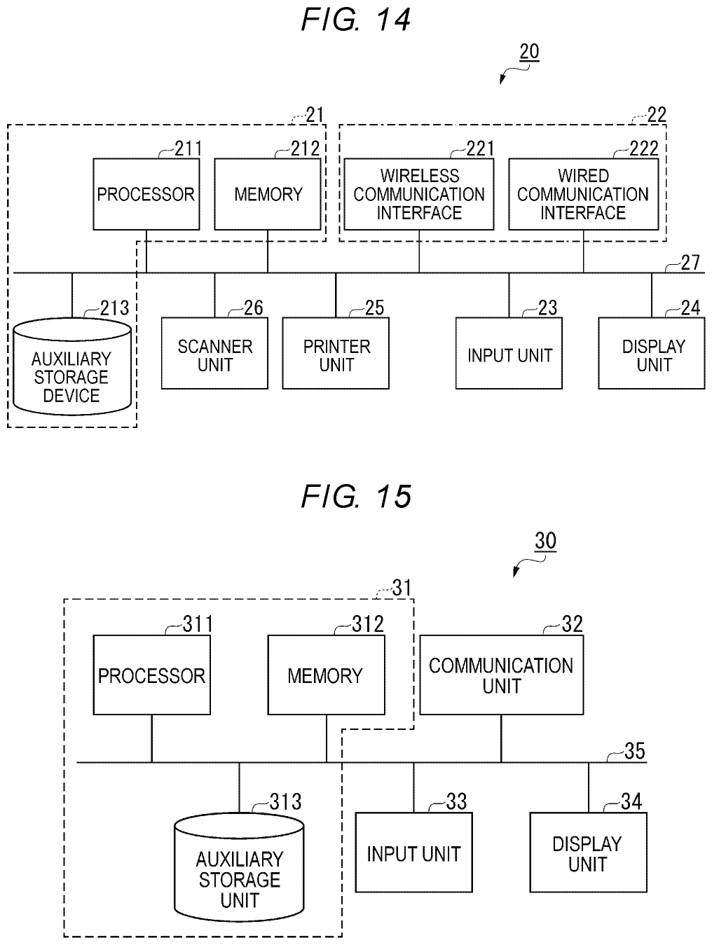

FIG. 14 is a diagram showing a configuration example of the multifunction peripheral 20 according to the present embodiment. For example, the multifunction peripheral 20 includes a processor 211, a memory 212, an auxiliary storage device 213, a communication unit 22, an input unit 23, a display unit 24, a printer unit 25, a scanner unit 26, and a bus 27 connecting the above. The multifunction peripheral 20 functions as one information processing device that provides multifunction peripheral functions by causing the processor 211 to read a program stored in the auxiliary storage device 213 into the memory 212 and execute the program. For example, the program referred to here is a program such as a BIOS, an OS, and various pieces of firmware.

The processor 211, the memory 212, and the auxiliary storage device 213 are not limited to specific ones as long as the multifunction peripheral 20 can function as one information processing device that provides the multifunction peripheral functions. For example, the processor 211 is a CPU. The processor 211 may include a GPU. Further, for example, the memory 212 is a RAM. The memory 212 may include a ROM. The auxiliary storage device 213 is configured using a storage device such as a magnetic hard disk device or a semiconductor storage device.

All or a part of each function of the multifunction peripheral 20 may be realized using hardware such as an ASIC, a PLD, and a FPGA. The program may be recorded on a computer-readable recording medium. The computer-readable recording medium is, for example, a portable medium such as a flexible disk, a magneto-optical disk, a ROM, a CD-ROM, or a storage device such as a hard disk built in a computer system. The program may be transmitted via a telecommunication line.

The processor 211, the memory 212, and the auxiliary storage device 213 function as a control unit 21. The control unit 21 plays a role as a controller that causes the multifunction peripheral 20 to function as one information processing device that provides multifunction peripheral functions. The control unit 21 has a function of transmitting device information of its own device to the requesting wireless communication terminal 10, in response to a request from the wireless communication terminal 10. Further, the control unit 21 has a function of executing a specified multifunction peripheral function in response to a request from the wireless communication terminal 10. The control unit 21 stores various setting information for realizing these functions in the auxiliary storage device 213.

The configuration of the control unit 21 is not limited to a specific configuration as long as the multifunction peripheral 20 can function as one information processing device that provides the multifunction peripheral function by executing a program. For example, the processor 211 is a CPU. The processor 211 may include a GPU. Further, for example, the memory 212 is a RAM. The memory 212 may include a ROM.

The auxiliary storage device 213 is configured using a storage device such as a magnetic hard disk device or a semiconductor storage device. The auxiliary storage device 213 stores in advance various setting information for realizing the functions of the control unit 21. Specifically, the auxiliary storage device 213 stores, as setting information, information for the control unit 21 to generate device information of its own device.

The auxiliary storage device 213 temporarily stores, for example, the print instruction information acquired from the wireless communication terminal 10. The auxiliary storage device 213 stores, for example, N pieces of profile information in advance.

The communication unit 22 is configured using a communication interface. The communication unit 22 connects the multi function peripheral 20 and the wireless communication terminal 10 to be able to communicate with each other by wireless communication. The communication unit 22 connects the multifunction peripheral 20 and the print distribution server 30 to be able to communicate with each other by wire communication or wireless communication. Here, it is assumed that the communication unit 22 includes a wireless communication interface 221 and a wired communication interface 222. Thus, the multifunction peripheral 20 can directly or indirectly communicate with the wireless communication terminal 10 and the print distribution server 30.

The input unit 23 is configured using input devices such as a touch panel, a mouse, and a keyboard. The input unit 23 receives inputs of various operations on the multifunction peripheral 20 and outputs the input information to the processor 211. The multifunction peripheral 20 executes various multifunction peripheral functions by causing the processor 211 to execute a process corresponding to the input information. For example, when the processor 211 executes a process according to the input information, a user authentication process is executed. Then, the print data is downloaded from the print distribution server 30, and print processing based on the downloaded print data is executed.

The display unit 24 is configured using a display device such as a CRT display, a liquid crystal display, and an organic EL display. The display unit 24 displays various information related to the operation of the multifunction peripheral 20. For example, information to be displayed by the display unit 24 is output from the processor 211.

The printer unit 25 (e.g., printer) forms an image on a sheet based on scan data generated by the scanner unit 26 and scan data received via a communication path. For example, the printer unit 25 includes an image forming unit (not shown) for forming a desired image on a sheet, a sheet storage unit (not shown) for storing sheets, and the like. The image forming unit forms an electrostatic latent image on a photosensitive drum (not shown) based on the scan data and forms the formed electrostatic latent image on a sheet using a developer. The developer is, for example, a toner. The toner may be a decolorable toner that decolorizes at a predetermined temperature or higher. The image forming unit heats and presses the sheet with a fixing device (not shown) to fix the electrostatic latent image visualized by the toner on the sheet. The sheet on which the image is formed may be a sheet stored in the sheet storage unit or may be a manually fed sheet.

The scanner unit 26 (e.g., scanner) reads the appearance of the object to be read based on brightness and darkness of light according to an instruction from the control unit 21. For example, the scanner unit 26 captures an image of the object to be read by using an image sensor such as a Charge Coupled Device (CCD) or a Contact Image Sensor (CIS). The scanner unit 26 outputs the scan data of the captured image of the object to be read to the control unit 21.

Hereinafter, the configuration of the print distribution server 30 will be described.

FIG. 15 is a diagram showing a configuration example of the print distribution server 30 in the present embodiment. For example, the print distribution server 30 includes a processor 311, a memory 312, an auxiliary storage device 313, a communication unit 32, an input unit 33, a display unit 34, and a bus 35 connecting the above. The print distribution server 30 functions as one information processing device that provides a print data distribution function by causing the processor 311 to read a program stored in the auxiliary storage device 313 into the memory 312 and execute the program. For example, the program referred to here is a program such as a BIOS, an OS, and various pieces of firmware.

The processor 311, the memory 312, and the auxiliary storage device 313 are not limited to specific ones as long as the print distribution server 30 can function as one information processing device that provides a print data distribution function. For example, the processor 311 is a CPU. The processor 311 may include a GPU. Further, for example, the memory 312 is a RAM. The memory 312 may include a ROM. The auxiliary storage device 313 is configured using a storage device such as a magnetic hard disk device or a semiconductor storage device.

All or a part of each function of the print distribution server 30 may be realized by using hardware such as an ASIC, a PLD, and a FPGA. The program may be recorded on a computer-readable recording medium. The computer-readable recording medium is, for example, a portable medium such as a flexible disk, a magneto-optical disk, a ROM, a CD-ROM, or a storage device such as a hard disk built in a computer system. The program may be transmitted via a telecommunication line.

The processor 311, the memory 312, and the auxiliary storage device 313 function as a control unit 31. The control unit 31 plays a role as a controller that causes the print distribution server 30 to function as one information processing device that provides a print data distribution function. The control unit 31 has a function of storing the print data transmitted from the multifunction peripheral 20 in the auxiliary storage device 313. Further, the control unit 31 has a function of transmitting the print data stored in the auxiliary storage device 313 to the requesting multifunction peripheral 20 in response to a request from the multifunction peripheral 20. The control unit 31 stores various setting information for realizing these functions in the auxiliary storage device 313.

The configuration of the control unit 31 is not limited to a specific configuration as long as the print distribution server 30 can function as one information processing device that provides a print data distribution function by executing a program. For example, the processor 311 is a CPU. The processor 311 may include a GPU. Further, for example, the memory 312 is a RAM. The memory 312 may include a ROM.

The auxiliary storage device 313 is configured using a storage device such as a magnetic hard disk device or a semiconductor storage device. The auxiliary storage device 313 stores in advance various setting information for realizing the functions of the control unit 31. Specifically, the auxiliary storage device 313 stores, as setting information, information for the control unit 31 to generate device information of its own device. The auxiliary storage device 313 stores, for example, the print data transmitted from the multifunction peripheral 20.

The communication unit 32 is configured using a communication interface. The communication unit 32 connects the print distribution server 30 and the multifunction peripheral 20 to be able to communicate with each other. Thereby, the multifunction peripheral 20 can directly or indirectly communicate with the multifunction peripheral 20.

The input unit 33 is configured using input devices such as a touch panel, a mouse, and a keyboard. The input unit 33 receives inputs of various operations on the print distribution server 30 and outputs input information to the processor 311.

The display unit 34 is configured using a display device such as a CRT display, a liquid crystal display, and an organic EL display. The display unit 34 displays various information related to the operation of the print distribution server 30. For example, information to be displayed by the display unit 34 is output from the processor 311.

Hereinafter, a flow of processing performed by the multifunction peripheral system 1 of the present embodiment will be described.

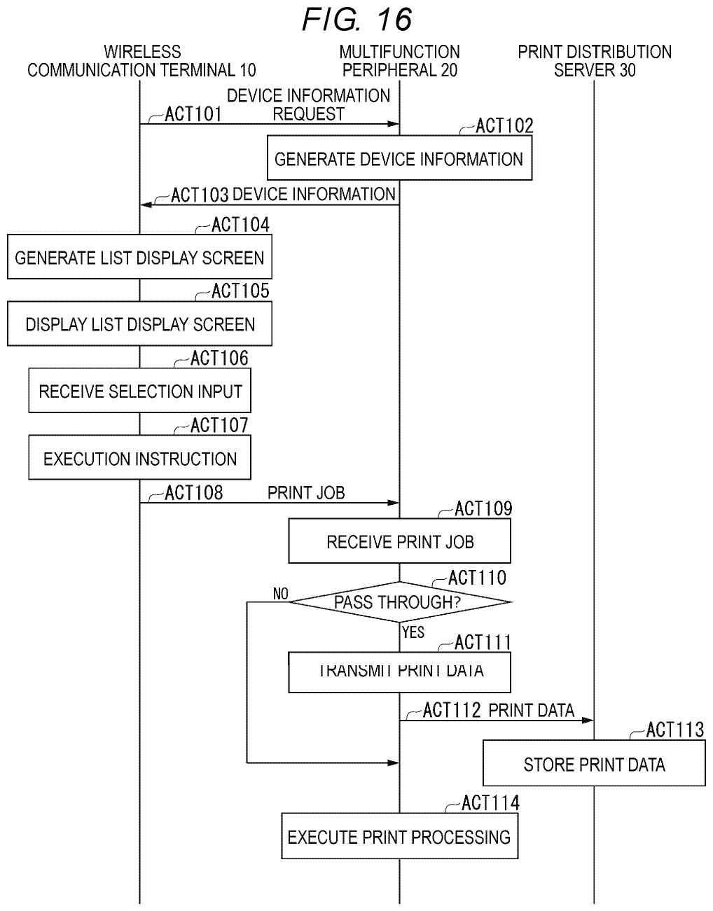

FIG. 16 is a sequence diagram showing a flow of a process performed by the multifunction peripheral system 1 according to the present embodiment. In the current example, the wireless communication terminal 10 and the multifunction peripheral 20 are wirelessly connected to each other at the start of a series of processes shown in FIG. 16. The multifunction peripheral 20 and the print distribution server 30 are connected to each other by wired or wireless connection. Also, the multifunction peripheral application is being executed in the wireless communication terminal 10 at the start of the series of processes shown in FIG. 16. In this state, it is assumed that the multifunction peripheral application is waiting for an input of an operation for selecting any one of the multifunction peripheral functions from a plurality of multifunction peripheral functions.

In this state, first, the user inputs an operation for selecting a multifunction peripheral function to be used for the multifunction peripheral application. The control unit 11 of the wireless communication terminal 10 executes a process of searching for an available multifunction peripheral 20 according to the input of the operation. Specifically, the control unit 11 transmits a response request for device information by broadcast (ACT 101: device information request). This device information request is received by each multifunction peripheral 20 participating in the same network as that of the wireless communication terminal 10. In FIG. 16, one multifunction peripheral 20 is shown for purposes of clarity.

Subsequently, in the multifunction peripheral 20, the control unit 21 generates device information to be transmitted to the requesting wireless communication terminal 10 in response to receiving the device information request (ACT 102). The control unit 21 transmits the generated device information to the requesting wireless communication terminal 10 (ACT 103). The wireless communication terminal 10 receives the device information transmitted from each multifunction peripheral 20.

The control unit 11 of the wireless communication terminal 10 generates a list display screen showing a list of device information of the available multifunction peripherals based on the device information acquired from each multifunction peripheral 20 (ACT 104). The control unit 11 causes the display unit 14 to display the generated list display screen (ACT 105).

The control unit 11 receives an input of an operation for selecting any one of the multifunction peripherals 20 displayed on the list display screen (ACT 106). The control unit 11 instructs the selected multifunction peripheral 20 to execute the multi function peripheral function specified by the user (ACT 107: execution instruction). Here, it is assumed that the execution of the printer function is instructed.

Based on the instruction to execute the printer function, the control unit 11 transmits a print job to the selected multifunction peripheral 20 (ACT 108). The print job includes the above-described print data and print instruction information.

The control unit 21 of the multifunction peripheral 20 receives the print job transmitted from the wireless communication terminal 10 (ACT 109). The control unit 21 determines whether or not to pass through based on the print instruction information included in the acquired print job (ACT 110).

If it is determined that the pass-through is to be performed (ACT 110: YES), the control unit 21 transmits the print data included in the acquired print job to the print distribution server 30 (ACT 112). The control unit 31 of the print distribution server 30 acquires the print data transmitted from the multifunction peripheral 20 and stores the print data in the auxiliary storage device 313 (ACT 113).

On the other hand, when it is determined that the pass-through is not performed (ACT 110: NO), the control unit 21 executes print processing based on the acquired print data (ACT 114).

As described above, the process performed by the multifunction peripheral system 1 indicated by the sequence diagram of FIG. 16 ends.

According to the multifunction peripheral system 1 of the embodiment configured as described above, it is possible to execute the printer function by a common method regardless of the usage environment of the user. Specifically, for example, even when the printer function is used from the wireless communication terminal 10 such as a smartphone, the print data can be passed through, similarly to the case where the printer function is used from a PC or the like. Thus, even when the printer function is used from the wireless communication terminal 10, the user can execute the print processing in any multifunction peripheral 20, similarly to the case where the printer function is used from a PC or the like.

Further, according to the multifunction peripheral system 1 of the embodiment, no matter which multifunction peripheral 20 displayed on the list display screen is selected by the user, if the condition for performing pass-through is satisfied, the print data is stored in the print distribution server 30. As described above, the user only needs to select any of the multifunction peripherals 20 and does not need to know the installation location of the multifunction peripheral 20 specified as the transmitting destination of the print data.

Further, according to the multifunction peripheral system 1 of the embodiment, it is easy to flexibly determine the execution method of the print function based on the print instruction information and the profile information. As a result, for example, it is possible to construct a multifunction peripheral system that operates based on a criterion that matches the operation of a print management service or solution provided by a business operator.

As described above, the multifunction peripheral system 1 according to the embodiment can improve user convenience in using the functions of the multifunction peripheral.

Further, according to the multifunction peripheral system 1 of the embodiment, pass-through can be performed only when a specific condition is satisfied based on the print instruction information and the profile information. That is, when the specific condition is satisfied, the print processing is not immediately started in the multifunction peripheral 20 after the execution instruction of the printer function is issued. Thereby, for example, it is possible to prevent a printed matter output from the multifunction peripheral 20 from being stolen by another person.

Further, according to the multifunction peripheral system 1 of the embodiment, pass-through can be prevented from being performed only when a specific condition is satisfied based on the print instruction information and the profile information. That is, when the specific condition is satisfied, the print data is not transmitted to the print distribution server 30. Thereby, it is possible to prevent, for example, unauthorized access to the print distribution server 30 and browsing and falsification of the print data.

As described above, the multifunction peripheral system 1 according to the embodiment can improve security in using the functions of the multifunction peripheral according to the usage environment.

Although several embodiments of the present invention have been described, these embodiments are provided by way of example and are not intended to limit the scope of the invention. These embodiments can be implemented in other various forms, and various omissions, substitutions, and changes can be made without departing from the gist of the invention. These embodiments and their modifications are included in the scope and gist of the invention and are also included in the invention described in the claims and equivalents thereof.

“Decoloring” in the embodiment means that an image formed with a color different from the background color of the paper (including not only chromatic colors but also achromatic colors such as white and black) is visually invisible.

(In this embodiment, ‘decoloring’ means to make it difficult to recognize a color of an image formed on an image receiving member after the image is formed on the image receiving member by a recording material which has different color from the color of the image receiving material. The color of recording material may be achromatic color including black or white, not limiting to chromatic color. And in the following embodiment, ‘decoloring the image’ means ‘erasing the image’.)

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image forming apparatus comprising:
a memory configured to store setting information;
a controller configured to determine whether to transmit image forming data to a distribution server based on the setting information; and
a communication unit configured to receive the image forming data from a terminal and to transmit the image forming data to the distribution server based on the determination.

2. The apparatus according to claim 1, further comprising:
an image forming unit configured to form an image based on the image forming data in response to the controller determining not to transmit the image forming data to the distribution server.

3. The apparatus according to claim 1, wherein
the communication unit is further configured to store the setting information received from the terminal in the memory.

4. The apparatus according to claim 1, wherein
the memory stores profile information indicating a criterion for the determination, and
the control unit is configured to determine whether to transmit the image forming data to the distribution server based on the setting information and the profile information.

5. The apparatus according to claim 1, wherein
the setting information includes information indicating at least one of: a type, a name, or a version of an application stored in the terminal.

6. The apparatus according to claim 1, wherein
the setting information includes information for identifying at least one of the terminal or the type of the terminal, and information indicating at least one of the versions of the terminal.

7. The apparatus according to claim 1, wherein
the setting information includes information indicating a file format of the image forming data.

8. The apparatus according to claim 2, further comprising:
an operation input unit configured to receive an operation input by a user, wherein
the control unit receives image forming data from the distribution server in response to the operation input, and
the image forming unit forms an image based on the image forming data received from the distribution server.

9. An image forming method, comprising:
acquiring, using a receiver, image forming data from a terminal;
determining, using a controller, whether to transmit the image forming data to a distribution server based on setting information; and
transmitting, using a communication unit, the image forming data to the distribution server according to the determination.

10. A non-transitory recording medium storing a program for causing
a computer of an image forming apparatus to execute:
acquiring image forming data from a terminal;
determining whether or not to transmit the image forming data to a distribution server based on setting information; and
transmitting the image forming data to the distribution server according to the determination.

11. The method according to claim 9, further comprising:
forming an image based on the image forming data in response to determining not to transmit the image forming data to the distribution server.

12. The method according to claim 9, further comprising:
determining whether to transmit the image forming data to the distribution server further based on profile information that includes a criterion for the determination.

13. The method according to claim 9, wherein
the setting information includes information indicating at least one of: a type, a name, or a version of an application stored in the terminal.

14. The method according to claim 9, wherein
the setting information includes information that identifies at least one of the terminal or the type of the terminal, and information indicating at least one of the versions of the terminal.

15. The method according to claim 9, wherein
the setting information includes information indicating a file format of the image forming data.
